(19) United States
(12) Patent Application Publication
(10) Pub. No.: US 2010/0164989 A1
(43) Pub. Date: Jul. 1, 2010

(54) SYSTEM AND METHOD FOR MANIPULATING ADVERTS AND INTERACTIVE

(75) Inventors: Eyal Margalit, Modi'in (IL); Nir Hagshury, Tel Aviv (IL)

Correspondence Address: Fleit Gibbons Gutman Bongini & Bianco PL, 21355 EAST DIXIE HIGHWAY, SUITE 115, MIAMI, FL, 33180, US

(73) Assignee: TICTACTI LTD., Modi' in (IL)

(21) Appl. No.: 12/676,236

(22) PCT Filed: Aug. 11, 2008
(86) PCT No.: PCT/IL2008/001102

§ 371 Date: Mar. 3, 2010

(30) Foreign Application Priority Data
Sep. 3, 2007 (IL) 185675

(51) Int. Cl. G09G 5/00

(52) U.S. Cl. 345/629

(57) ABSTRACT

A superimposed data placement system adapted to overlay a content video with an electronic overlay layer embedded with a plurality of superimposed data, comprising one or more members of a group consisting of video content stored on N at least one first server; means for analyzing said content; means for creating an electronic overlay layer adapted to be seamlessly superimposed upon said content; first means for streaming said content layer; second means for streaming said overlay layer; means for synchronizing said first stream with said second stream; wherein said content layer is independent of said overlay layer and is both stored and streamed unaltered in its original form.

### FIELD OF THE INVENTION

The present invention generally pertains to improving user interaction with online adverts and interactive communications by facilitating control over adverts interlinked to online content, and more specifically by utilizing an overlay interface to manipulate the content and physical attributes of adverts interlinked to website content.

### BACKGROUND OF THE INVENTION

Provision of so-called ‘free’ online content by means of the web, is increasingly funded by integrated advertising. Often this advertising is placed within the page of the content, in a window-within-window format. Another form of conventional web based adverts are pop-up windows that overlay a new window on top of the content page. Yet another form of conventional adverts overlay a floating advert, often semi-transparent, on top of the content page. Whether confronted by overlay pop-ups or by adverts that share the space of the content window, the user has no control over the location, size, audible volume or content of the adverts. Indeed, users are quite often antagonized by the unexpected and uncontrolled relay of adverts. This has a negative effect on the propensity of the users to further investigate and perhaps purchase the product being advertised, and may eventually also alienate them from the content website altogether. Moreover, conventional forms of integrated advertisement rely on differing versions of web technologies such as HTML and Flash, and on web-browser specific or website specific construction methods, in order to assure that they operate properly. This often results in improper presentation of adverts and content errors, serving to further distance users from both the content and the adverts. Finally, conventional adverts tap into the same computing resources that provide the content, thereby draining these resources and degrading the quality and speed of actual content provision.

The commercially available Google-DoubleClick™, Yahoo!-Right Media™, WPP Group-24/7 Real Media™ and Microsoft-aQuantive™ deals are all attempts to own the best technology and data-analysis tools for online ad targeting. By serving ads to people based on their online activities, behavioral targeting promises to reach a more engaged audience with fewer ad impressions.

Online video advertising holds great promise. The high engagement factor of video combined with the Internet's tracking and targeting capabilities, offers a valuable revenue stream for Web publishers and a highly accountable method for brand advertisers to sway the hearts and minds of target audiences.

Next year represents a mass-market benchmark, as more than 50% of the US population—155.2 million people—will watch video online. How this audience reacts to online video advertising will ultimately shape the future of the format.

Product placement, or embedded marketing, is a type of advertising, in which promotional advertisements placed by marketers using real commercial products and services in media, where the presence of a particular brand is the result of an economic exchange. When featuring a product is not part of an economic exchange, it is called a product plug. Product placement appears in plays, film, television series, music videos, video games and books. It became more common starting in the 1980s, but can be traced back as early as 1949. Product placement occurs with the inclusion of a brand's logo in shot, or a favorable mention or appearance of a product in shot. This is done without disclosure, and under the premise that it is a natural part of the work. Most major movie releases today contain product placements. The most common form is movie and television placements and more recently computer and video games. Recently, websites have experimented with in-site product placement as a revenue model.

In early media, e.g. radio in the 1930s and 1940s and early television in the 1950s, programs were often underwritten by companies. “Soap operas” are called such because they were initially underwritten by consumer packaged goods companies such as Procter & Gamble or Unilever. Sponsorship still exists today with programs being sponsored by major vendors such as Hallmark. Incorporation of products into the actual plot of a TV show is generally called “brand integration”. A recent example is HBO's Sex in the City, where the plot revolved around, among other things, Absolut Vodka, a campaign upon which one of the protagonists was working, and a billboard in Times Square, where a bottle prevented an image of the model from being pornographic. Knight Rider, a TV series featuring a talking Pontiac Trans Am, is another example of brand integration.

Actual product placement, according to ERMA.org, a Hollywood product placement association falls into two categories: products or locations that are obtained from manufacturers or owners to reduce the cost of production, and products deliberately placed into productions in exchange for fees.

A very early example of product placement in film occurs in the 1946 film It's a Wonderful Life by Frank Capra where a young boy with aspirations to be an explorer displays a prominent copy of National Geographic. Another is in the 1949 film Love Happy, in which Harpo Marx cavorts on a rooftop among various billboards and at one point escapes from the villains on the old Mobil logo, the “Flying Red Horse”. In addition, the first film to win the Oscar for Best Picture, Wings (released in 1927), contained a plug for Hershey's.

Another very early example potentially occurs in Jules Verne's Around the World in Eighty Days in which transport and shipping companies lobbied to be mentioned as it was initially published in serial form.

Still another example is the conspicuous display of Studebaker motor vehicles in the television show Mr. Ed, which was sponsored by the Studebaker Corporation from 1961 to 1963.

The earliest example of product placement in a computer or video game occurs in the 1984 game Action Biker for KP's Skips crisps.

The earliest example of product placement in a cartoon occurs in the Comedy Central show: Shorties Watchin' Shorties.

Virtual product placement uses computer graphics to insert the product into the program after the program is complete.

As of 2007, a new trend is emerging in product placement, the development of capabilities that permit dynamic or switchable product placement. Previously post production tools have permitted one time insertion of new product placement images and billboard advertising, e.g. at baseball or hockey games. As of 2007, new startups are offering or developing the ability to switch product placement. First generation virtual product placement has tended to be based upon sports arenas where the geometrical relationships of camera and the surface of the flat area onto which the billboard is projected, can be easily calculated. Second generation product placement or dynamic product placement is more focused upon commercial products. Third generation virtual or dynamic product placement allows targeting of customers with different products that can be dynamically switched based upon e.g. demographics, psychographics or behavioral information about the consumer. Also of interest are hypervideo techniques that can insert interactive elements into online video.

WO08010203 discloses a method for embedding artwork in videos, the method comprising: obtaining an original video, marking a segment of said original video, thereby defining a marked segment, and implanting a container within said marked segment; selecting an artwork piece for said container, automatically placing said artwork piece within said container, thereby rendering a modified video segment wherein said artwork piece is animated in accordance with said marked segment.

WO 2008062211 discloses a method of preparing video material for distribution comprising: providing a repository of video material; analysing video material to define placement zones for placement of digital advertising components; electronically placing one or more digital advertising components in video material; and outputting video material for distribution. It additionally discloses a method of tracking the features of the video material, e.g. changes in lighting, and matching these with amendments to the digital advertising components, thereby creating an integrated impression.

WO08010203 and WO 2008062211 share a common approach towards facilitating interchangeable product placement. Their approach consists of: retrieving the original video from the storage means of a video publisher, analyzing it for placement zones suitable for product or Advert placement, editing the original video and implanting (defining) therein invisible containers (placement holders), and finally storing the edited version of the video in the storage means of said video publisher. Subsequently the aforementioned predefined zones may be filled with products or adverts that have been found appropriate for a particular audience.

Note that these methods for virtual product placement rely on a process of retrieving, editing and storing of an edited version that is fraught with shortcomings. The step of editing may be hindered by videos that have been encoded with protection against copying, editing or otherwise tampering with the content, for example DRM protection. The step of retrieving includes transferring the entire file, at bandwidth connection expense, from the publisher's means of storage to an ‘editing table’ available to the implanter of ‘placement holder’. The step of storing the edited version requires yet another transfer of the entire file from the editing table to the storage means. Furthermore, once placement zones are defined and stored the entire process, i.e. retrieving, editing and storing, must be repeated in order to make amendments or add zones. This difficulty could be partially overcome by defining a large number of zones during the first run of the process. However, doing so would substantially increase the size of the video. Note that this may raise objections from video publishers, since the burden of storing the video falls upon the publisher. Moreover the increase of file size attributed to a plurality of unused invisible placement holders would strain bandwidth to no purpose.

Currently all Ad Junction like Right Media, Double Click etc' can only monetize banners (i.e. 468×60, 234×60, text link) placed on HTML pages, meaning that their Ad Server's can only count impression, clicks, actions and revenues from standard Tags like IFrame Tags or JavaScript Tags. Their current technology doesn't allow them to serve banners on videos.

It is therefore a well felt need to provide an easily accessible advert toolbar and interface module, and an interconnected media player that is independent of web browsing technology and does not drain the computing resources that provide the web content, such that said advert toolbar and interface module enable the user to manipulate the physical attributes and optionally restrict the content of said adverts. It is a further long felt need to provide a system and method for virtual product placement in a video stored in any standard format, whilst leaving the original content unaltered. Thus the entire file content need not be retrieved from the publisher's storage means, invasive actions need not be applied to the content during editing, the edited version need not be returned to the publisher for storage, and the file size of the content stored and streamed from the publisher's storage means remains unchanged. It is a further long felt need to mask, replace or hide objects that appear in video content. It is a further long felt need to provide product and image placement displacement or purging in copy-protected videos that will not allow editing of the original content. It is a further long felt need that products or images added to streamed original content in video format be revenue producing by means of conventional banner click revenue models.

### SUMMARY OF THE INVENTION

It is a an object of the present invention to disclose a media viewing control system (‘TicTacTi™’) that manipulates the presentation of adverts interlinked to web based content, wherein a floating Graphic User Interface (GUI), constantly overlaying any other window of content, enables control of the physical attributes and the content of said adverts said system comprising: at least one content website; at least one advert interlinked to said content website; at least one means for superimposing a virtual toolbar over said content website; at least one GUI means integrated into said toolbar that controls the settings of a plurality of physical attributes and content restrictions of said advert; at least one means for applying said settings to said advert; and, at least one means for displaying said advert in accordance with said settings.

It is within the scope of the present invention that the above mentioned GUI allows the user to enter user attributes, selected from a group consisting of (i) age, (ii) gender, (iii) characteristics and interests, and (iv) postcode and hence to manipulate the content of said presented adverts.

It is yet another object of the present invention to disclose an electronic overlay layer adapted to be seamlessly superimposed onto a video content layer, comprising at least one video content layer (VCL) stored on at least one first server; at least one superimposed data (SID) stored on at least one second server; at least one means for superimposing said SID onto said VCL; wherein said content layer is independent of said overlay layer and is stored unaltered in its original form.

It is within the scope of the present invention to disclose an overlay layer additionally comprising a means for masking objects within said VCL.

It is within the scope of the present invention to disclose an overlay layer additionally comprising electronic tagging means of at least one object embedded within said content layer, such that said tagging means is embedded in said overlay layer.

It is within the scope of the present invention to disclose an overlay layer additionally comprising means for superimposing at least one SID upon said content layer, said image selected from a group consisting of: still images, films, augmented reality, illustrations, highlights, script, animation, hologram, hyperlink, or a combination thereof.

It is within the scope of the present invention to disclose an overlay layer, wherein the visual characteristics of said SID are selected from a group consisting of opaque, semi-transparent, transparent, 2 dimensional (2D), 3 dimensional (3D) or a combination thereof.

It is within the scope of the present invention to disclose an overlay layer, wherein said means for superimposing said SID onto said VCL superimposes SIDs selected from a group consisting of images, films, augmented reality, illustrations, highlights, script, simulation, hologram, animation, questionnaires, data tickers, RSS that are updated automatically or a combination thereof.

It is within the scope of the present invention that in the case that objects masked by said SIDs are larger than said masking SIDs within said overlay layer thereby providing a visible margin; wherein said system additionally comprising means for analyzing the pixels surrounding said masked object within said content layer, and means for inserting a patch in the dimension of said visible margins and the color and texture composition of said surrounding pixels into said overlay layer, such that said margins are masked by said patch.

It is within the scope of the present invention that media viewing control system, additionally comprising an electronic overlay layer adapted to be seamlessly superimposed onto a video content layer, comprising at least one video content layer (VCL) stored on at least one first server; at least one superimposed data (SID) stored on at least one second server; and, at least one means for superimposing said SID onto said VCL.

It is within the scope of the present invention that above mentioned overlay layer additionally comprises a means for electronic tagging of objects embedded within said content.

It is within the scope of the present invention that above mentioned overlay layer additionally comprising means for superimposing at least one visible SID upon said content layer, said image selected from a group consisting of: still images, films, augmented reality, illustrations, highlights, script, animation, hologram, hyperlink, or a combination thereof.

It is yet another object of the present invention to disclose a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream; wherein said content layer is independent of said overlay layer and is both stored and streamed unaltered in its original form.

It is within the scope of the present invention that said SID placement system additionally comprising a means for encrypting or otherwise copy-protecting said content against editing, tampering and altering.

It is within the scope of the present invention that the above mentioned content layer comprises images selected from a group consisting of still images, films, augmented reality, illustrations, highlights, script, simulation, hologram, animation, questionnaires, data tickers, RSS that are updated automatically or a combination thereof.

It is within the scope of the present invention that said SID placement system, additionally comprising a means for clicking said images.

It is within the scope of the present invention that said SID placement system additionally comprising a means for hyper linking said images.

It is within the scope of the present invention that said SID placement system additionally comprising a means for charging revenue for said clicking of said images.

It is within the scope of the present invention that said SID placement system, additionally comprising means for emulating the behavior of standard HTML, thereby causing Ad Servers to treat images contained within said overlay layer as if they were standard banners served on standard HTML pages.

It within the scope of the present invention that the above mentioned synchronizing means is selected from a group consisting of bitmap time synchronization, cue point event synchronization, or a combination thereof.

It is within the scope of the present invention that said SID placement system additionally comprising means for masking at least one object embedded within said content layer.

It is within the scope of the present invention that the above mentioned analyzing means is adapted for object tracking.

It is within the scope of the present invention that the above mentioned analyzing means is an offline recorded-feed analyzing means.

It is within the scope of the present invention that the above mentioned analyzing means is an online live-feed analyzing means.

It is within the scope of the present invention that said SID placement system additionally comprising means for manipulating the visual characteristics of images embedded within said overlay layer; said characteristics consisting of one or more members of a group consisting of size, color, shading, opacity, lighting, texture, orientation, or a combination thereof.

It is within the scope of the present invention that said SID placement system additionally comprising sync monitor means for monitoring video player events; said events are selected from a group consisting of buffering, stopping play, pausing play or a combination thereof, and matching the sequence of overplayed bitmap frames to said events.

It is within the scope of the present invention that said SID placement system additionally comprising means for analyzing the pixels surrounding said masked object within said content layer, and a means for incorporating a patch in the dimension of said visible margins and the color and texture composition of said surrounding pixels into said overlay layer, such that said margins are masked by said patch.

It is yet another object of the present invention to disclose a method for superimposing an overlay layer onto a content video; said method comprising steps of obtaining a system adapted to overlay a content video with an electronic overlay layer; creating an electronic overlay layer adapted to be seamlessly superimposed upon said content; synchronizing the streaming of said overlay layer with the streaming of said content; and, playing said synchronized content to the viewer; wherein said content layer is independent of said overlay layer and is both stored and streamed unaltered in its original form.

It is within the scope of the present invention to disclose a method for superimposing an overlay layer onto a content video, comprising an additional step of encrypting, otherwise copy-protecting against editing, tampering or altering.

It is within the scope of the present invention to disclose a method for superimposing an overlay layer onto a content video, comprising an additional step of formatting said overlay layer into a series of bitmap frames.

It is within the scope of the present invention to disclose a method for superimposing an overlay layer onto a content video, wherein said synchronizing step comprising a step of selecting a format from a group consisting of bitmap time synchronizing, cue point event synchronization, or a combination thereof.

It is within the scope of the present invention to disclose a method for superimposing an overlay layer onto a content video, comprising an additional step of suspending the play of said synchronized content.

It is within the scope of the present invention to disclose a method for superimposing an overlay layer onto a content video, comprising an additional step of clicking images embedded within said overlay layer.

It is within the scope of the present invention to disclose a method for superimposing an overlay layer onto a content video, comprising an additional step of hyperlinking images embedded with said overlay layer.

It is within the scope of the present invention to disclose a method for superimposing an overlay layer onto a content video, comprising an additional step of emulating the behavior of standard HTML, thereby causing Ad Servers to treat images contained within said overlay layer as if they were standard banners served on standard HTML pages.

It is within the scope of the present invention to disclose a method for superimposing an overlay layer onto a content video, comprising an additional step of masking objects embedded in said content layer by superimposing said objects with SIDs embedded in said overlay layer.

It is within the scope of the present invention to disclose a method for superimposing an overlay layer onto a content video, additionally comprising a step of monitoring said synchronized playing and suspending the play of said content layer, said overlay layer or a combination thereof in order to achieve optimal synchronization.

It is within the scope of the present invention to disclose a method for superimposing an overlay layer onto a content video, additionally comprising a step of buffering said streamed content layer, overlay layer, or a combination thereof.

It is within the scope of the present invention to disclose a method for superimposing an overlay layer onto a content video, additionally comprising a step of manipulating the visual characteristics SIDs embedded within said overlay layer, said characteristics consisting of: size, color, shading, opacity, lighting, texture, orientation, or a combination thereof.

It is within the scope of the present invention to disclose a method for superimposing an overlay layer onto a content video, additionally comprising a step of controlling the duration of appearance of said superimposed overlay layer

It is within the scope of the present invention to disclose a method for superimposing an overlay layer onto a content video, provided in case that said step of masking provides a visible margin of the masked object visible, comprising an additional step of analyzing the pixels surrounding said masked object within said content layer, and inserting a visual patch in the dimension of said visible margins and in the color and texture composition of said surrounding pixels into said overlay layer, thereby masking said margins by said patch.

It is yet another object of the present invention to disclose a method for charging revenue on clickable images or products, said method comprising steps of: obtaining a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream; emulating the behavior of standard HTML, thereby causing Ad Servers to treat images contained within said overlay layer as if they were standard banners served on standard HTML pages; counting clicks on said images; and, calculating revenue charges; wherein said images or products are viewed in a video stream

It is yet another object of the present invention to disclose a revenue system adapted for generating revenue according to clicks on images or products, comprising: video content stored on a server; a means for emulating the behavior of standard HTML, thereby causing Ad Servers to treat images contained within said video content as if they were standard banners served on standard HTML pages; a means for counting clicks on said images; and, a means for calculating revenue charges; wherein said images or products are viewed in a video stream

It within the scope of the present invention to disclose a method for charging revenue on clickable images or products, additionally comprising a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream.

It within the scope of the present invention to disclose a method for charging revenue on clickable images or products, comprising an additional step of hyperlinking said viewed images or products.

It is yet another object of the present invention to disclose an authoring tool adapted for embedding SIDs in a video overlay layer, comprising: at least one drag-and-drop user interface; and, at least one database of SIDs adapted for superimposing; wherein a graphical laymen can generate an overlay layer by self service means.

It is within the scope of the present invention to disclose the above mentioned authoring tool wherein said authoring tool is a web application.

It is yet another object of the present invention to disclose a method for embedding images in a video overlay layer, said method comprising steps of: obtaining an authoring tool adapted for embedding SIDs in a video overlay layer, comprising: at least one drag-and-drop user interface; and, at least one database of SIDs adapted for superimposing; and, embedding said SIDs selected by drag-and-drop means in said overlay layer; wherein a graphical laymen can generate an overlay layer by self service means. It is within the scope of the present invention to disclose the above mentioned media viewing control system, wherein said physical attributes of said advert controlled by said GUI means are selected from a group consisting of: (1) physical location, (2) size, (3) translucence, (4) audible volume and (5) content.

It is within the scope of the present invention to disclose the above mentioned media viewing control system, wherein said content restrictions of said advert are selected from a group consisting of: (1) offensive content, (2) relevance of advert to user in accordance with said predetermined user attributes.

It is within the scope of the present invention to disclose the above mentioned media viewing control system, wherein said toolbar is interactive.

It is within the scope of the present invention to disclose the above mentioned media viewing control system, additionally comprising a means, embedded in said toolbar, for drawing the viewers attention to commercially available products that have been electronically tagged within said overlay layer and appear during the viewing of said content, said means selected from a group consisting of an icon related to said product, an animation effect activated thereupon, or a combination thereof.

It is within the scope of the present invention to disclose the above mentioned media viewing control system, additionally comprising means for manipulating said icon, said manipulating selected from consisting of: flash, expansion, jitter, revolution, fade in and fade out, visual manipulation of border lines, or a combination thereof.

It is within the scope of the present invention to disclose the above mentioned media viewing control system, wherein said icon is selected from a group consisting of: a miniature version of said commercial product, an illustration of said commercial product; any standard sign indicating information, any standard sign indicating purchase, or a combination thereof.

It is within the scope of the present invention to disclose the above mentioned media viewing control system, additionally comprising means for highlighting or generating a hue onto said product.

It is within the scope of the present invention to disclose the above mentioned media viewing control system, additionally comprising means for indicating interest in said icon displayed within said toolbar.

It is within the scope of the present invention to disclose the above mentioned media viewing control system, additionally comprising means for purchasing said product.

It is within the scope of the present invention to disclose the above mentioned media viewing control system, additionally comprising means for drawing the attention of the viewer to brands related to the viewed content.

It is within the scope of the present invention to disclose the above mentioned media viewing control system, additionally comprising means for drawing the attention of the viewer to promotion messages related to the viewed content selected from a group consisting of: promotion of related content, promotion of special deals available from retailers on commercial products embedded in said content, promotion of surveys related to said content.

It is within the scope of the present invention to disclose the above mentioned media viewing control system, additionally comprising push-advertising oriented means.

It is within the scope of the present invention to disclose the above mentioned media viewing control system, additionally comprising means for relaying wherein advertising displayed and surveys presented to the audience in real time, corresponding to events occurring in the live content the audience is viewing.

It is within the scope of the present invention to disclose the above mentioned media viewing control system, additionally comprising means for displaying, within said toolbar, information related to said advert content, including: (1) previous users rating of said advert, (2) offensiveness of said advert content.

It is within the scope of the present invention to disclose the above mentioned media viewing control system, wherein said advert is a video stream.

It is within the scope of the present invention to disclose the above mentioned media viewing control system, additionally comprising a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream;, wherein the seamless integration of said SID with said content video generates the impression that said SIDs are embedded in said content video.

It is within the scope of the present invention to disclose the above mentioned media viewing control system, additionally comprising means, within said toolbar, for controlling the progression of said video stream.

It is within the scope of the present invention to disclose the above mentioned media viewing control system, additionally comprising proprietary media player that is independent of user specific computer setup, including: (1) browser type, (2) browser version, (3) operating system, and (4) flash version.

It is within the scope of the present invention to disclose the above mentioned media viewing control system, wherein said toolbar is translucent.

It is within the scope of the present invention to disclose the above mentioned media viewing control system, additionally comprising means within said toolbar to disable said toolbar.

It is within the scope of the present invention to disclose the above mentioned media viewing control system, additionally comprising means for dissolving said toolbar dissolves from view after a predetermined period of inactivity.

It is within the scope of the present invention to disclose the above mentioned media viewing control system, additionally comprising means for restoring the visibility wherein said toolbar regains visibility as the result of a predetermined action, including (1) keyboard stroke, and (2) mouse movement.

It is within the scope of the present invention to disclose the above mentioned media viewing control system, additionally comprising user interface means for manipulating the position of said overlay advert, said user interface selected from a group consisting of clickable arrow icons, and click-and-drop.

It is within the scope of the present invention to disclose the above mentioned media viewing control system, additionally comprising a means for contextually linking the advert to the content of the webpage being viewed.

It is within the scope of the present invention to disclose the above mentioned media viewing control system, additionally comprising a means for superimposing the advertising with one or more members selected from the following group freehand drawing, predetermined shapes, icons or images, by means of an additional drawing toolbar.

It is yet another object of the present invention to disclose a method for manipulating the presentation of adverts interlinked to web based content, comprising: obtaining a system that manipulates the presentation of adverts interlinked to web based content, wherein a floating (GUI), constantly overlaying any other window of content, enables control of the physical attributes and the content of said adverts; setting the and size and location for said advert to presented, by means of said interactive GUI floating toolbar; presenting said advert according to said predetermined settings; observing the content of said website; dissolving the visibility of said GUI floating toolbar; and, enabling the visibility of said GUI floating toolbar.

It is within the scope of the present invention to disclose a method for manipulating the presentation of adverts interlinked to web based content, additionally comprising a step of inputting content-determining user attributes, by means of said interactive GUI floating toolbar.

It is within the scope of the present invention to disclose a method for manipulating the presentation of adverts interlinked to web based content, additionally comprising a step of automatically dissolving the visibility of said GUI floating toolbar after a period of inactivity.

It is within the scope of the present invention to disclose a method for manipulating the presentation of adverts interlinked to web based content, additionally comprising a step of automatically revealing said GUI floating toolbar as a response to user activity, including: (1) moving the mouse, (2) keyboard strokes.

It is within the scope of the present invention to disclose a method for manipulating the presentation of adverts interlinked to web based content, additionally comprising a step of opening an overlay proprietary media player, and streaming a video ad therein.

It is within the scope of the present invention to disclose a method for manipulating the presentation of adverts interlinked to web based content, wherein said overlaid video ad is seamlessly superimposed upon said content, thereby creating the impression that said video ad is embedded in said content.

It is within the scope of the present invention to disclose a method for manipulating the presentation of adverts interlinked to web based content, additionally comprising a step of drawing the attention of the viewer to promotions selected from a group consisting of: related content, special deals available from retailers on commercial products embedded in said content, surveys related to said content, brands related to viewing content.

It is within the scope of the present invention to disclose a method for manipulating the presentation of adverts interlinked to web based content, additionally comprising a step of prompting the viewer to explore said promotions.

It is within the scope of the present invention to disclose a method for manipulating the presentation of adverts interlinked to web based content, additionally comprising a step of manipulating the position of the advert by clicking arrow tags adjacent to the border of said overplayed advert.

It is within the scope of the present invention to disclose a method for manipulating the presentation of adverts interlinked to web based content, additionally comprising a step of manipulating the position of the advert by clicking and dragging it.

It is within the scope of the present invention to disclose a method for manipulating the presentation of adverts interlinked to web based content, additionally comprising a step of gauging the popularity of the content by embedding an advert in it and counter of the number of times the advert was displayed.

It is within the scope of the present invention to disclose a method for manipulating the presentation of adverts interlinked to web based content, additionally comprising a step of prompting the viewer to enter a list of keywords, attributes, interests or preferences, and consequently matching the advert to said information provided by the viewer.

It is within the scope of the present invention to disclose a method for manipulating the presentation of adverts interlinked to web based content, additionally comprising a step of matching the advert attached to said content by means a list of predetermined keywords that has been attached to said content.

It is within the scope of the present invention to disclose a method for manipulating the presentation of adverts interlinked to web based content, additionally comprising a step of matching the advert attached to said content by analyzing the audible content in real time by means of conventional speech recognition.

It is within the scope of the present invention to disclose a method for manipulating the presentation of adverts interlinked to web based content, additionally comprising a step of displaying, said icon related to said commercial product embedded in said content, within said toolbar.

It is within the scope of the present invention to disclose a method for manipulating the presentation of adverts interlinked to web based content, additionally comprising a step of animating said icon, wherein said animating consists of an action selected from a list consisting of: flashing, expanding, jittering, revolving, fading in and out, or a combination thereof.

It is within the scope of the present invention to disclose a method for manipulating the presentation of adverts interlinked to web based content, additionally comprising a step of the viewer indicating interest in further information or wishing to purchase a viewed product, by means of virtually depressing said icon.

It is within the scope of the present invention to disclose a method for manipulating the presentation of adverts interlinked to web based content, additionally comprising a step of indicating which of said products of interest the viewer would like to proceed and purchase.

It is within the scope of the present invention to disclose a method for manipulating the presentation of adverts interlinked to web based content, additionally comprising a step of purchasing said products of interest.

It is within the scope of the present invention to disclose a method for manipulating the presentation of adverts interlinked to web based content, additionally comprising a step of activating a link to an online retail website.

It is within the scope of the present invention that the above mentioned media viewing control system and/or toolbar are adapted to analyze the user interactive telecommunications activity and choices between the different telecommunication protocols options, including: SMS, MMS and IVR.

### BRIEF DESCRIPTION OF THE FIGURES

In order to better understand the invention and its implementation in practice, a plurality of embodiments will now be described, by way of non-limiting example only, with reference to the accompanying drawings, in which

FIG. 1 illustrates a set of particular embodiments of overlay GUI floating toolbars (10A, 10B and 10C) for controlling the physical attributes and content of adverts interlinked to website content.

FIG. 2 illustrates a set of particular embodiments of overlay GUI floating toolbars (30a, 30b) adapted to interface between the viewer and objects of interest to said user electronically tagged by an overlay layer that leaves the content layer uninterrupted.

FIG. 3 illustrates an exploded view of a preferred embodiment of a SID placement system adapted to superimpose an electronic overlay layer onto a content video, wherein said content layer is independent of said overlay layer.

FIGS. 4a and 4b respectively illustrate a comparative schematic view of bandwidth strain on web connections in prior art versus the present invention.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an easily accessible control module for manipulating the physical attributes and restricting the content of adverts interlinked to web content, and an interconnected media player that does not drain the computer resources that provide said content; useful for improving user interaction with web based advertisement.

The system of the present invention has many technological advantages, among them: Reducing antagonism towards advert funded websites; Reducing errors due to incompatibilities with specific web-browsers and web technologies; Facilitating control over physical attributes of web adverts; and Facilitating filtering of the content of web adverts. Additional features and advantages of the invention will become apparent from the following drawings and description.

The term ‘masks’ or ‘masking’ interchangeably refers hereinafter to superimposing a first graphical object with a second graphical object, such that said first is no longer visible.

The term ‘Push advertising’ refers hereinafter to all efforts to get the word out to an entire group of potential customers in order to hit the few that many be currently interested in your product or service. Most traditional offline advertising efforts (magazine, billboard, newspaper, tv, classifieds, etc) as well as online banners ads and email broadcasts are considered push marketing.

The term ‘video’ or ‘video content’ interchangeably refers hereinafter to visual content whether in two or three dimensions that exhibits a motion aspect, selected from a group consisting of: film, video, animation, hologram, video games, simulations, or a combination thereof.

The term ‘Product Placement’ refers hereinafter to a type of advertising, in which promotional advertisements placed by marketers using real commercial products and services in media, where the presence of a particular brand is the result of an economic exchange. When featuring a product is not part of an economic exchange, it is called a product plug. Product placement appears in plays, film, television series, music videos, video games and books. It became more common starting in the 1980s, but can be traced back to at least 1949. Product placement occurs with the inclusion of a brand's logo in shot, or a favorable mention or appearance of a product in shot. This is done without disclosure, and under the premise that it is a natural part of the work. Most major movie releases today contain product placements. The most common form is movie and television placements and more recently computer and video games. Recently, websites have experimented with in-site product placement as a revenue model.

The term ‘overlay’ refers hereinafter to superimposing an overlay layer upon a a video content layer thereby creating a visual impression, by means of a synchronized photomontage effect, that objects within the overlay layer are integrated in the content layer. Moreover, the overlay layer may mask objects within the content layer thereby enabling product placement superimposed upon a content layer.

The term ‘object tracking’ is the critical task in many computer vision applications such as surveillance, perceptual user interfaces, augmented reality, smart rooms, object-based video compression, and driver assistance.

The term ‘Augmented reality (AR)’ is a field of computer research which deals with the combination of real-world and computer-generated data. At present, most AR research is concerned with the use of live video imagery which is digitally processed and “augmented” by the addition of computer-generated graphics. Advanced research includes the use of motion-tracking data, fiducial marker recognition using machine vision, and the construction of controlled environments containing any number of sensors and actuators.

The term ‘Publisher’ refers hereinafter to a body that has means for streaming dynamic content. Examples of current web based publishers are: Channel.TV, Youtube.com, and Bebo.com. The format of published content may consist of video on demand (VOD), live event, user generated content (UGC), broadcasting live channels, or a combination thereof.

The term ‘video content owner’ refers hereinafter to the legal owner-of video content be said content self produced and owned by a private individual, or commercially produced and owned by means of assigning rights.

The term ‘Advertiser’ refers hereinafter to any legally accountable body that wishes to advertise itself in conjunction with playing of web based video content. An advertiser may be an advert agency, a branding company and ad junction or a combination thereof.

The term ‘Advert’ refers hereinafter to traditional adverts or branding adverts, either in conventional web advert advert form selected from a group consisting of: banners, text links, and flash, or by advanced product placement enabled by visually analyzing the content, tagging it and overlaying it with product placement.

The term ‘Creative Community’ refers hereinafter to artists skilled in creating images for populating an overlay layer.

The term ‘Online Overlay Generation’ refers hereinafter to a self-service automated overlay generation system that automates the generation of objects including images, banners, text and links to be incorporated within an overlay layer. Said objects may be utilized to mask or swap objects within the content layer. For example a commercial bottle, or the label thereof, may be superimposed onto a similar object in the content layer.

The term ‘placement zone’ refers to a space, void or surface in at least one frame of a content video that may be superimposed by an element contained within an overlay layer, said element selected from a group consisting of: a logo, a brand, an image, a product image, a moto, a text, a link, or a combination thereof.

The term ‘superimposed data’ (SID), refers hereinafter to members selected from a group consisting of: still images, films, augmented reality, illustrations, highlights, script, animation, hologram, hyperlink, or a combination thereof.

The term ‘bitmap’ or ‘pixmap’ refers hereinafter to a spatially mapped array of pixels.

The term ‘bitmap time synchronizing’ refers to a method for synchronizing an overlay layer with a content layer, wherein the overlay layer and the content layer are streamed to the viewer's computing means. Both streams remain suspend while the overlay layer is split into an array of bitmap frames. The video is then played and once a predetermined frame of the content layer is reached said bitmap frames are superimposed upon said content layer. For example if the overlay layer contains an object that is to be display from timeline 60 sec to timeline 65 sec, on a video running at 25 frames per second, then the split overlay layer will contain 625 bitmap frames to be superimposed onto the overlay layer.

The term ‘cue point event synchronization’ refers to a method for synchronizing an overlay layer with a content layer, wherein the overlay layer and the content layer are streamed to the viewer's computing means. Both streams remain suspend while the overlay layer is split into an array of bitmap frames. The video is then played and once a predetermined time has elapsed of the content layer is reached said bitmap frames are superimposed upon said content layer.

The term ‘sync monitor’ refers hereinafter to a means for monitoring video player events selected from a group consisting of: buffering, stopping play, pausing play or a combination thereof, and matching the sequence of overplayed bitmap frames to said events.

The term ‘live feed’ refers hereinafter to a video stream of a live event such as a football game.

The term ‘recorded feed’ refers hereinafter to a video stream of a previously recorded video.

The term ‘object’ refers hereinafter to any visual depiction of actual objects, backgrounds, voids or spaces, contained within a video, or a combination thereof.

The term ‘data ticker’ refers hereinafter to information services that provide information to Web Pages or to any electronic device with broadcasting capabilities by wireless or Web based feeds.

The term ‘RSS’ refers hereinafter to a family of Web feed formats used to publish frequently updated content such as blog entries, news headlines, and podcasts in a standardized format.

The term ‘emulating’ refers hereinafter to duplicating the functions of one system using a different system, so that the second system behaves like (and appears to be) the first system. This focus on exact reproduction of external behavior is in contrast to some other forms of computer simulation, which can concern an abstract model of the system being simulated.

The term ‘embedded’ refers hereinafter to the action of integration, such that the element being embedded is united with element it is being integrated in, such that the two become one. For example, once an image is embedded in a background image, they become united into one image. By contrast, in the action of layering images or superimposing them, each layer remains independent.

The term ‘stream’ refers hereinafter to a method of broadcasting media to a viewer from a distant point, the means of broadcasting may include radio wave broadcasting, web based broadcast, satellite broadcast, landline broadcast, cable broadcast, or a combination thereof.

A SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream; It is acknowledged that the content layer is in any standard video format.

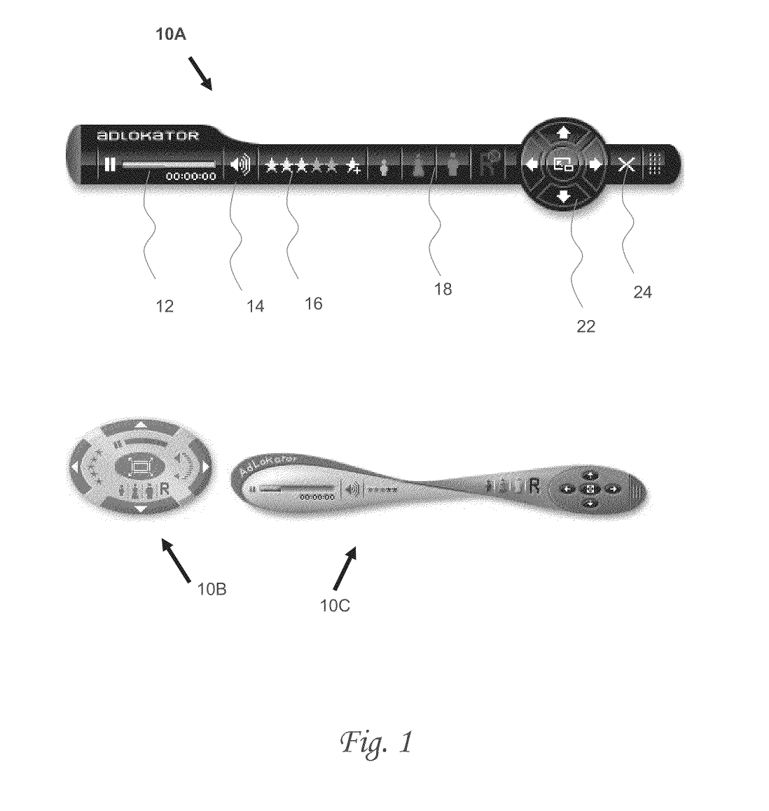

Reference is made now to FIG. 1 illustrating a top view of a particular embodiment of overlay Graphic User Interface (GUI) floating toolbar 10, facilitating a GUI floating toolbar that displays and controls the advert stream (12), volume (14), rating (16), content filtering (18), location (22), and its own physical attributes (24).

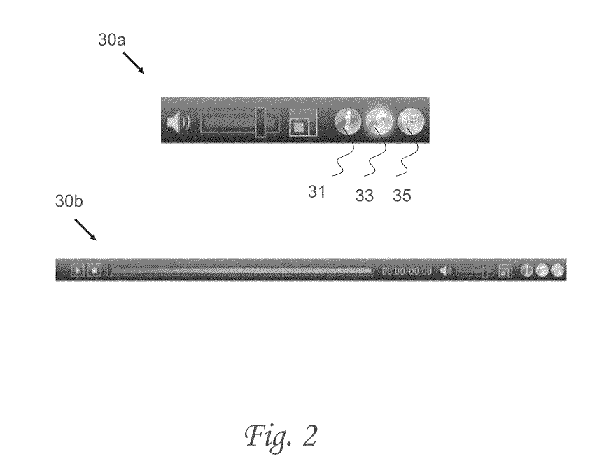

Reference is made now to FIG. 2 illustrating a top view of a preferred embodiment of overlay Graphic User Interface (GUI) floating toolbars 30a and 30b, facilitating a GUI floating toolbar that draws the viewer's attention to objects that have been electronically tagged within an overlay layer (not shown) that is superimposed upon a content layer (not shown); said attention being drawn by means of the virtual manipulation of icon (31) representing the availability of further information about said tagged object, (33) representing the commercial availability of said object, and (35) representing the purchase of said tagged object.

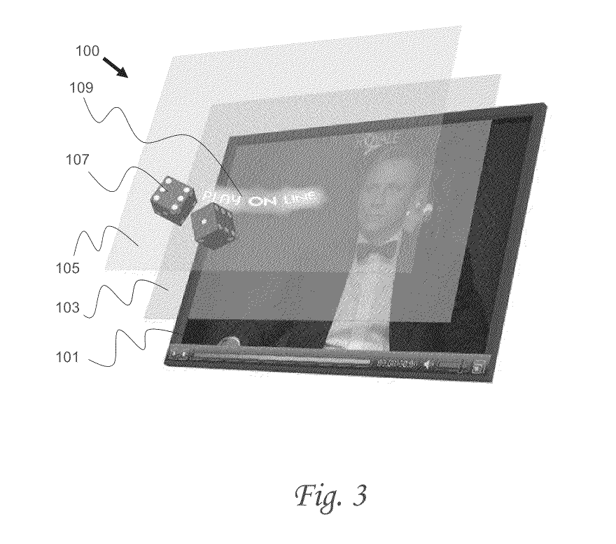

Reference is made now to FIG. 3 illustrating an exploded view of a preferred embodiment of a SID placement system adapted to overlay a content video with an electronic overlay layer such that said content layer is left unaltered in its original form, wherein original streamed video content 101, is superimposed by object tagging layer 103, and additionally superimposed by advert overlay layer 105, said overlay layer comprising image 107 and script 109.

Reference is now made to another embodiment of the present invention illustrating a media viewing control system that manipulates the presentation of adverts interlinked to web based content, wherein a floating Graphic User Interface (GUI), constantly overlaying any other window of content, enables control of the physical attributes and the content of said adverts said system comprising: at least one content website; at least one advert interlinked to said content website; at least one means for superimposing a virtual toolbar over said content website; at least one GUI means integrated into said toolbar that controls the settings of a plurality of physical attributes and content restrictions of said advert; at least one means for applying said settings to said advert; and, at least one means for displaying said advert in accordance with said settings.

Reference is now made to another embodiment of the present invention illustrating a media viewing control system that manipulates the presentation of adverts interlinked to web based content, wherein said GUI allows the user to enter user attributes, selected from a group consisting of (i) age, (ii) gender, (iii) characteristics and interests, and (iv) postcode and hence to manipulate the content of said presented adverts.

Reference is now made to another embodiment of the present invention illustrating a media viewing control system that manipulates the presentation of adverts interlinked to web based content, additionally comprising an electronic overlay layer adapted to be seamlessly superimposed onto a video content layer, comprising at least one video content layer (VCL) stored on at least one first server; at least one superimposed data (SID) stored on at least one second server; and, at least one means for superimposing said SID onto said VCL.

Reference is now made to another embodiment of the present invention illustrating a media viewing control system that manipulates the presentation of adverts interlinked to web based content, additionally comprising a means for electronic tagging of objects embedded within said content.

Reference is now made to another embodiment of the present invention illustrating a media viewing control system that manipulates the presentation of adverts interlinked to web based content, wherein said overlay layer additionally comprising means for superimposing at least one visible SID upon said content layer, said image selected from a group consisting of: still images, films, augmented reality, illustrations, highlights, script, animation, hologram, hyperlink, or a combination thereof.

Reference is now made to another embodiment of the present invention illustrating a media viewing control system that manipulates the presentation of adverts interlinked to web based content, wherein said physical attributes of said advert controlled by said GUI means are selected from a group consisting of: (1) physical location, (2) size, (3) translucence, (4) audible volume and (5) content.

Reference is now made to another embodiment of the present invention illustrating a media viewing control system that manipulates the presentation of adverts interlinked to web based content, wherein said content restrictions of said advert are selected from a group consisting of: (1) offensive content, (2) relevance of advert to user in accordance with said predetermined user attributes.

Reference is now made to another embodiment of the present invention illustrating a media viewing control system that manipulates the presentation of adverts interlinked to web based content, wherein said toolbar is interactive.

Reference is now made to another embodiment of the present invention illustrating a media viewing control system that manipulates the presentation of adverts interlinked to web based content, additionally comprising a means, embedded in said toolbar, for drawing the viewers attention to commercially available products that have been electronically tagged within said overlay layer and appear during the viewing of said content, said means selected from a group consisting of an icon related to said product, an animation effect activated thereupon, or a combination thereof.

Reference is now made to another embodiment of the present invention illustrating a media viewing control system that manipulates the presentation of adverts interlinked to web based content, additionally comprising means for manipulating said icon, said manipulating selected from consisting of: flash, expansion, jitter, revolution, fade in and fade out, visual manipulation of border lines, or a combination thereof.

Reference is now made to another embodiment of the present invention illustrating a media viewing control system that manipulates the presentation of adverts interlinked to web based content, wherein said icon is selected from a group consisting of: a miniature version of said commercial product, an illustration of said commercial product; any standard sign indicating information, any standard sign indicating purchase, or a combination thereof.

Reference is now made to another embodiment of the present invention illustrating a media viewing control system that manipulates the presentation of adverts interlinked to web based content, additionally comprising means for highlighting or generating a hue onto said product.

Reference is now made to another embodiment of the present invention illustrating a media viewing control system that manipulates the presentation of adverts interlinked to web based content, additionally comprising means for indicating interest in said icon displayed within said toolbar.

Reference is now made to another embodiment of the present invention illustrating a media viewing control system that manipulates the presentation of adverts interlinked to web based content, additionally comprising means for purchasing said product.

Reference is now made to another embodiment of the present invention illustrating a media viewing control system that manipulates the presentation of adverts interlinked to web based content, additionally comprising means for drawing the attention of the viewer to brands related to the viewed content.

Reference is now made to another embodiment of the present invention illustrating a media viewing control system that manipulates the presentation of adverts interlinked to web based content, additionally comprising means for drawing the attention of the viewer to promotion messages related to the viewed content selected from a group consisting of: promotion of related content, promotion of special deals available from retailers on commercial products embedded in said content, promotion of surveys related to said content.

Reference is now made to another embodiment of the present invention illustrating a media viewing control system that manipulates the presentation of adverts interlinked to web based content, additionally comprising push-advertising oriented means.

Reference is now made to another embodiment of the present invention illustrating a media viewing control system that manipulates the presentation of adverts interlinked to web based content, additionally comprising means for relaying wherein advertising displayed and surveys presented to the audience in real time, corresponding to events occurring in the live content the audience is viewing.

Reference is now made to another embodiment of the present invention illustrating a media viewing control system that manipulates the presentation of adverts interlinked to web based content, additionally comprising means for displaying, within said toolbar, information related to said advert content, including: (1) previous users rating of said advert, (2) offensiveness of said advert content.

Reference is now made to another embodiment of the present invention illustrating a media viewing control system that manipulates the presentation of adverts interlinked to web based content, wherein said advert is a video stream.

Reference is now made to another embodiment of the present invention illustrating a media viewing control system that manipulates the presentation of adverts interlinked to web based content, additionally comprising a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream;, wherein the seamless integration of said SID with said content video generates the impression that said SIDs are embedded in said content video.

Reference is now made to another embodiment of the present invention illustrating a media viewing control system that manipulates the presentation of adverts interlinked to web based content, additionally comprising means, within said toolbar, for controlling the progression of said video stream.

Reference is now made to another embodiment of the present invention illustrating a media viewing control system that manipulates the presentation of adverts interlinked to web based content, additionally comprising proprietary media player that is independent of user specific computer setup, including: (1) browser type, (2) browser version, (3) operating system, and (4) flash version.

Reference is now made to another embodiment of the present invention illustrating a media viewing control system that manipulates the presentation of adverts interlinked to web based content, wherein said toolbar is translucent.

Reference is now made to another embodiment of the present invention illustrating a media viewing control system that manipulates the presentation of adverts interlinked to web based content, additionally comprising means within said toolbar to disable said toolbar.

Reference is now made to another embodiment of the present invention illustrating a media viewing control system that manipulates the presentation of adverts interlinked to web based content, additionally comprising means for dissolving said toolbar dissolves from view after a predetermined period of inactivity.

Reference is now made to another embodiment of the present invention illustrating a media viewing control system that manipulates the presentation of adverts interlinked to web based content, additionally comprising means for restoring the visibility wherein said toolbar regains visibility as the result of a predetermined action, including (1) keyboard stroke, and (2) mouse movement.

Reference is now made to another embodiment of the present invention illustrating a media viewing control system that manipulates the presentation of adverts interlinked to web based content, additionally comprising user interface means for manipulating the position of said overlay advert, said user interface selected from a group consisting of clickable arrow icons, and click-and-drop.

Reference is now made to another embodiment of the present invention illustrating a media viewing control system that manipulates the presentation of adverts interlinked to web based content, additionally comprising a means for contextually linking the advert to the content of the webpage being viewed.

Reference is now made to another embodiment of the present invention illustrating a media viewing control system that manipulates the presentation of adverts interlinked to web based content, additionally comprising a means for superimposing the advertising with one or more members selected from the following group freehand drawing, predetermined shapes, icons or images, by means of an additional drawing toolbar.

Reference is now made to another embodiment of the present invention illustrating a media viewing control system that manipulates the presentation of adverts interlinked to web based content, wherein the disclosed system and/or toolbar are adapted to analyze the user interactive telecommunications activity and choices between the different telecommunication protocols options, including: SMS, MMS and IVR.

Reference is now made to another embodiment of the present invention illustrating a method for manipulating the presentation of adverts interlinked to web based content, comprising: obtaining a system that manipulates the presentation of adverts interlinked to web based content, wherein a floating (GUI), constantly overlaying any other window of content, enables control of the physical attributes and the content of said adverts, setting the and size and location for said advert to presented, by means of said interactive GUI floating toolbar; presenting said advert according to said predetermined settings; observing the content of said website; dissolving the visibility of said GUI floating toolbar; and, enabling the visibility of said GUI floating toolbar.

Reference is now made to another embodiment of the present invention illustrating a method for manipulating the presentation of adverts interlinked to web based content, additionally comprising a step of inputting content-determining user attributes, by means of said interactive GUI floating toolbar.

Reference is now made to another embodiment of the present invention illustrating a method for manipulating the presentation of adverts interlinked to web based content, additionally comprising a step of automatically dissolving the visibility of said GUI floating toolbar after a period of inactivity.

Reference is now made to another embodiment of the present invention illustrating a method for manipulating the presentation of adverts interlinked to web based content, additionally comprising a step of automatically revealing said GUI floating toolbar as a response to user activity, including: (1) moving the mouse, (2) keyboard strokes.

Reference is now made to another embodiment of the present invention illustrating a method for manipulating the presentation of adverts interlinked to web based content, additionally comprising a step of opening an overlay proprietary media player, and streaming a video ad therein.

Reference is now made to another embodiment of the present invention illustrating a method for manipulating the presentation of adverts interlinked to web based content, wherein said overlaid video ad is seamlessly superimposed upon said content, thereby creating the impression that said video ad is embedded in said content.

Reference is now made to another embodiment of the present invention illustrating a method for manipulating the presentation of adverts interlinked to web based content, additionally comprising a step of drawing the attention of the viewer to promotions selected from a group consisting of: related content, special deals available from retailers on commercial products embedded in said content, surveys related to said content, brands related to viewing content.

Reference is now made to another embodiment of the present invention illustrating a method for manipulating the presentation of adverts interlinked to web based content, additionally comprising a step of prompting the viewer to explore said promotions.

Reference is now made to another embodiment of the present invention illustrating a method for manipulating the presentation of adverts interlinked to web based content, additionally comprising a step of manipulating the position of the advert by clicking arrow tags adjacent to the border of said overplayed advert.

Reference is now made to another embodiment of the present invention illustrating a method for manipulating the presentation of adverts interlinked to web based content, additionally comprising a step of manipulating the position of the advert by clicking and dragging it.

Reference is now made to another embodiment of the present invention illustrating a method for manipulating the presentation of adverts interlinked to web based content, additionally comprising a step of gauging the popularity of the content by embedding an advert in it and counter of the number of times the advert was displayed.

Reference is now made to another embodiment of the present invention illustrating a method for manipulating the presentation of adverts interlinked to web based content, additionally comprising a step of prompting the viewer to enter a list of keywords, attributes, interests or preferences, and consequently matching the advert to said information provided by the viewer.

Reference is now made to another embodiment of the present invention illustrating a method for manipulating the presentation of adverts interlinked to web based content, additionally comprising a step of matching the advert attached to said content by means a list of predetermined keywords that has been attached to said content.

Reference is now made to another embodiment of the present invention illustrating a method for manipulating the presentation of adverts interlinked to web based content, additionally comprising a step of matching the advert attached to said content by analyzing the audible content in real time by means of conventional speech recognition.

Reference is now made to another embodiment of the present invention illustrating a method for manipulating the presentation of adverts interlinked to web based content, additionally comprising a step of displaying, said icon related to said commercial product embedded in said content, within said toolbar.

Reference is now made to another embodiment of the present invention illustrating a method for manipulating the presentation of adverts interlinked to web based content, additionally comprising a step of animating said icon, wherein said animating consists of an action selected from a list consisting of: flashing, expanding, jittering, revolving, fading in and out, or a combination thereof.

Reference is now made to another embodiment of the present invention illustrating a method for manipulating the presentation of adverts interlinked to web based content, additionally comprising a step of the viewer indicating interest in further information or wishing to purchase a viewed product, by means of virtually depressing said icon.

Reference is now made to another embodiment of the present invention illustrating a method for manipulating the presentation of adverts interlinked to web based content, additionally comprising a step of indicating which of said products of interest the viewer would like to proceed and purchase.

Reference is now made to another embodiment of the present invention illustrating a method for manipulating the presentation of adverts interlinked to web based content, additionally comprising a step of purchasing said products of interest.

Reference is now made to another embodiment of the present invention illustrating a method for manipulating the presentation of adverts interlinked to web based content, additionally comprising a step of activating a link to an online retail website.

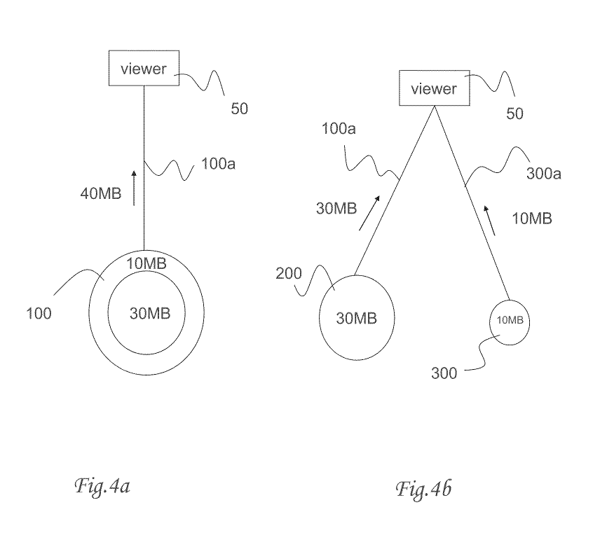

Reference is made now to FIGS. 4a and 4b illustrating a comparative schematic view of bandwidth strain on web connections. FIG. 4a illustrates bandwidth connection strain in prior art wherein video content 100 stored on a publishers server has been edited and embedded with placement advertising, thereby increasing the original content weighing 30 MB by 10 MB to the total of 40 MB. Said total of 40 MB is transmitted on demand via connection 100a connecting said server with viewer 50. FIG. 4b bandwidth connection strain in a particular embodiment of the present invention, where original unaltered video content 200 weighing 30 MB is stored on a publisher's server, overlay layer 30 containing place advertising and weighing 10 MB is stored on an ad server. On demand from viewer 50, connection 100a between the publisher's server and the viewer carries a reduced strain of 30 MB, whilst a different connection 300a from the ad server to the viewer carries 10 MB.

Reference is now made to another embodiment of the present invention illustrating an electronic overlay layer adapted to be seamlessly superimposed onto a video content layer, comprising at least one video content layer (VCL) stored on at least one first server; at least one superimposed data (SID) stored on at least one second server; at least one means for superimposing said SID onto said VCL; wherein said content layer is independent of said overlay layer and is stored unaltered in its original form.

Reference is now made to another embodiment of the present invention illustrating an electronic overlay layer adapted to be seamlessly superimposed onto a video content layer, additionally comprising a means for masking objects within said VCL.

Reference is now made to another embodiment of the present invention illustrating an electronic overlay layer adapted to be seamlessly superimposed onto a video content layer, wherein said overlay layer additionally comprising electronic tagging means of at least one object embedded within said content layer, such that said tagging means is embedded in said overlay layer.

Reference is now made to another embodiment of the present invention illustrating an electronic overlay layer adapted to be seamlessly superimposed onto a video content layer, additionally comprising means for superimposing at least one SID upon said content layer, said image selected from a group consisting of: still images, films, augmented reality, illustrations, highlights, script, animation, hologram, hyperlink, or a combination thereof.

Reference is now made to another embodiment of the present invention illustrating an electronic overlay layer adapted to be seamlessly superimposed onto a video content layer, wherein the visual characteristics of said SID are selected from a group consisting of opaque, semi-transparent, transparent, 2 dimensional (2D), 3 dimensional (3D) or a combination thereof.

Reference is now made to another embodiment of the present invention illustrating an electronic overlay layer adapted to be seamlessly superimposed onto a video content layer, wherein said means for superimposing said SID onto said VCL superimposes SIDs selected from a group consisting of images, films, augmented reality, illustrations, highlights, script, simulation, hologram, animation, questionnaires, data tickers, RSS that are updated automatically or a combination thereof.

Reference is now made to another embodiment of the present invention illustrating an electronic overlay layer adapted to be seamlessly superimposed onto a video content layer, in the case that objects masked by said SIDs are larger than said masking SIDs within said overlay layer thereby providing a visible margin; wherein said system additionally comprising means for analyzing the pixels surrounding said masked object within said content layer, and means for inserting a patch in the dimension of said visible margins and the color and texture composition of said surrounding pixels into said overlay layer, such that said margins are masked by said patch.

Reference is now made to another embodiment of the present invention illustrating a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream; wherein said content layer is independent of said overlay layer and is both stored and streamed unaltered in its original form.

Reference is now made to another embodiment of the present invention illustrating a SID placement system adapted to overlay a content video with an electronic overlay layer embedded with a plurality of SIDs, additionally comprising a means for encrypting or otherwise copy-protecting said content against editing, tampering and altering.

Reference is now made to another embodiment of the present invention illustrating a SID placement system adapted to overlay a content video with an electronic overlay layer embedded with a plurality of SIDs, wherein said content layer comprises images selected from a group consisting of still images, films, augmented reality, illustrations, highlights, script, simulation, hologram, animation, questionnaires, data tickers, RSS that are updated automatically or a combination thereof.

Reference is now made to another embodiment of the present invention illustrating a SID placement system adapted to overlay a content video with an electronic overlay layer embedded with a plurality of SIDs, additionally comprising a means for clicking said images.

Reference is now made to another embodiment of the present invention illustrating a SID placement system adapted to overlay a content video with an electronic overlay layer embedded with a plurality of SIDs, additionally comprising a means for hyper linking said images.

Reference is now made to another embodiment of the present invention illustrating a SID placement system adapted to overlay a content video with an electronic overlay layer embedded with a plurality of SIDs, additionally comprising a means for charging revenue for said clicking of said images.

Reference is now made to another embodiment of the present invention illustrating a SID placement system adapted to overlay a content video with an electronic overlay layer embedded with a plurality of SIDs, additionally comprising means for emulating the behavior of standard HTML, thereby causing Ad Servers to treat images contained within said overlay layer as if they were standard banners served on standard HTML pages.

Reference is now made to another embodiment of the present invention illustrating a SID placement system adapted to overlay a content video with an electronic overlay layer embedded with a plurality of SIDs, wherein said synchronizing means is selected from a group consisting of bitmap time synchronization, cue point event synchronization, or a combination thereof.

Reference is now made to another embodiment of the present invention illustrating a SID placement system adapted to overlay a content video with an electronic overlay layer embedded with a plurality of SIDs, additionally comprising means for masking at least one object embedded within said content layer.

Reference is now made to another embodiment of the present invention illustrating a SID placement system adapted to overlay a content video with an electronic overlay layer embedded with a plurality of SIDs, wherein said analyzing means is adapted for object tracking.

Reference is now made to another embodiment of the present invention illustrating a SID placement system adapted to overlay a content video with an electronic overlay layer embedded with a plurality of SIDs, wherein said analyzing means is an offline recorded-feed analyzing means.

Reference is now made to another embodiment of the present invention illustrating a SID placement system adapted to overlay a content video with an electronic overlay layer embedded with a plurality of SIDs, wherein said analyzing means is an online live-feed analyzing means.

Reference is now made to another embodiment of the present invention illustrating a SID placement system adapted to overlay a content video with an electronic overlay layer embedded with a plurality of SIDs, additionally comprising means for manipulating the visual characteristics of images embedded within said overlay layer; said characteristics consisting of one or more members of a group consisting of size, color, shading, opacity, lighting, texture, orientation, or a combination thereof.

Reference is now made to another embodiment of the present invention illustrating a SID placement system adapted to overlay a content video with an electronic overlay layer embedded with a plurality of SIDs, additionally comprising sync monitor means for monitoring video player events; said events are selected from a group consisting of buffering, stopping play, pausing play or a combination thereof, and matching the sequence of overplayed bitmap frames to said events.

Reference is now made to another embodiment of the present invention illustrating a SID placement system adapted to overlay a content video with an electronic overlay layer embedded with a plurality of SIDs, additionally comprising means for analyzing the pixels surrounding said masked object within said content layer, and a means for incorporating a patch in the dimension of said visible margins and the color and texture composition of said surrounding pixels into said overlay layer, such that said margins are masked by said patch.

Reference is now made to another embodiment of the present invention illustrating a method for superimposing an overlay layer onto a content video; said method comprising steps of obtaining a system adapted to overlay a content video with an electronic overlay layer; creating an electronic overlay layer adapted to be seamlessly superimposed upon said content; synchronizing the streaming of said overlay layer with the streaming of said content; and, playing said synchronized content to the viewer; wherein said content layer is independent of said overlay layer and is both stored and streamed unaltered in its original form.

Reference is now made to another embodiment of the present invention illustrating a method for superimposing an overlay layer onto a content video, comprising an additional step of encrypting, otherwise copy-protecting against editing, tampering or altering.

Reference is now made to another embodiment of the present invention illustrating a method for superimposing an overlay layer onto a content video, comprising an additional step of formatting said overlay layer into a series of bitmap frames.

Reference is now made to another embodiment of the present invention illustrating a method for superimposing an overlay layer onto a content video, wherein said synchronizing step comprising a step of selecting a format from a group consisting of bitmap time synchronizing, cue point event synchronization, or a combination thereof.

Reference is now made to another embodiment of the present invention illustrating a method for superimposing an overlay layer onto a content video, comprising an additional step of suspending the play of said synchronized content.

Reference is now made to another embodiment of the present invention illustrating a method for superimposing an overlay layer onto a content video, comprising an additional step of clicking images embedded within said overlay layer.

Reference is now made to another embodiment of the present invention illustrating a method for superimposing an overlay layer onto a content video, comprising an additional step of hyperlinking images embedded with said overlay layer.

Reference is now made to another embodiment of the present invention illustrating a method for superimposing an overlay layer onto a content video, comprising an additional step of emulating the behavior of standard HTML, thereby causing Ad Servers to treat images contained within said overlay layer as if they were standard banners served on standard HTML pages.

Reference is now made to another embodiment of the present invention illustrating a method for superimposing an overlay layer onto a content video, comprising an additional step of masking objects embedded in said content layer by superimposing said objects with SIDs embedded in said overlay layer.

Reference is now made to another embodiment of the present invention illustrating a method for superimposing an overlay layer onto a content video, additionally comprising a step of monitoring said synchronized playing and suspending the play of said content layer, said overlay layer or a combination thereof in order to achieve optimal synchronization.

Reference is now made to another embodiment of the present invention illustrating a method for superimposing an overlay layer onto a content video, additionally comprising a step of buffering said streamed content layer, overlay layer, or a combination thereof.

Reference is now made to another embodiment of the present invention illustrating a method for superimposing an overlay layer onto a content video, additionally comprising a step of manipulating the visual characteristics SIDs embedded within said overlay layer, said characteristics consisting of: size, color, shading, opacity, lighting, texture, orientation, or a combination thereof.

Reference is now made to another embodiment of the present invention illustrating a method for superimposing an overlay layer onto a content video, additionally comprising a step of controlling the duration of appearance of said superimposed overlay layer

Reference is now made to another embodiment of the present invention illustrating a method for superimposing an overlay layer onto a content video, provided in case that said step of masking provides a visible margin of the masked object visible, comprising an additional step of analyzing the pixels surrounding said masked object within said content layer, and inserting a visual patch in the dimension of said visible margins and in the color and texture composition of said surrounding pixels into said overlay layer, thereby masking said margins by said patch.

Reference is now made to another embodiment of the present invention illustrating a method for charging revenue on clickable images or products, said method comprising steps of: obtaining a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream; emulating the behavior of standard HTML, thereby causing Ad Servers to treat images contained within said overlay layer as if they were standard banners served on standard HTML pages; counting clicks on said images; and, calculating revenue charges; wherein said images or products are viewed in a video stream

Reference is now made to another embodiment of the present invention illustrating a revenue system adapted for generating revenue according to clicks on images or products, comprising: video content stored on a server; a means for emulating the behavior of standard HTML, thereby causing Ad Servers to treat images contained within said video content as if they were standard banners served on standard HTML pages; a means for counting clicks on said images; and, a means for calculating revenue charges; wherein said images or products are viewed in a video stream

Reference is now made to another embodiment of the present invention illustrating a method for charging revenue on clickable images or products, additionally comprising a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream.

Reference is now made to another embodiment of the present invention illustrating a method for charging revenue on clickable images or products, comprising an additional step of hyperlinking said viewed images or products.

Reference is now made to another embodiment of the present invention illustrating an authoring tool adapted for embedding SIDs in a video overlay layer, comprising: at least one drag-and-drop user interface; and, at least one database of SIDs adapted for superimposing; wherein a graphical laymen can generate an overlay layer by self service means.

Reference is now made to another embodiment of the present invention illustrating an authoring tool adapted for embedding SIDs in a video overlay layer, wherein said authoring tool is a web application.

Reference is now made to another embodiment of the present invention illustrating, method for embedding images in a video overlay layer, said method comprising steps of: obtaining an authoring tool adapted for embedding SIDs in a video overlay layer, comprising: at least one drag-and-drop user interface; and, at least one database of SIDs adapted for superimposing; and, embedding said SIDs selected by drag-and-drop means in said overlay layer; wherein a graphical laymen can generate an overlay layer by self service means.

1-94. (canceled)

95. A superimposed data (SID) placement system adapted to overlay a content video layer (VCL) with an electronic overlay layer embedded with a plurality of SIDs, comprising one or more members of a group consisting of: video content stored on at least one first server; means for analyzing said content; means for creating an electronic overlay layer adapted to be seamlessly superimposed upon said content; means for adapting said overlay layer to emulate the behavior of standard HTML page; first means for streaming said content layer; second means for streaming said overlay layer; and means for synchronizing said first stream with said second stream; wherein said emulation of the behavior of standard HTML page causes Ad Servers to treat images and placement zones contained within said overlay layer as if they were standard banners served on standard HTML pages.

96. The system according to claim 95, additionally comprising a means for charging revenue for viewer cursor and mouse actions on said SIDs, placement zones, or a combination thereof

97. The system according to claim 95, additionally comprising means for masking at least one object embedded within said content layer, by images or SIDs in said overlay layer.

98. The system according to claim 95, wherein said analyzing means is an online live-feed analyzing means.

99. The system according to claim 95, additionally comprising sync monitor means for monitoring video player events; said events are selected from a group consisting of buffering, stopping play, pausing play or a combination thereof, and matching the sequence of overplayed bitmap frames to said events.

100. The system according to claim 99, additionally comprising means for analyzing the pixels surrounding said masked object within said content layer, and a means for incorporating a patch in the dimension of said visible margins and the color and texture composition of said surrounding pixels into said overlay layer, such that said margins are masked by said patch.

101. A method for superimposing an overlay layer onto a content video; said method comprising steps of obtaining a system adapted to overlay a content video with an electronic overlay layer; creating an electronic overlay layer adapted to be seamlessly superimposed upon said content; synchronizing the streaming of said overlay layer with the streaming of said content; and, playing said synchronized content to the viewer; wherein said content layer is independent of said overlay layer and is both stored and streamed unaltered in its original form.

102. The method according to claim 101, comprising an additional step of formatting said overlay layer into a series of bitmap frames.

103. The method according to claim 101, wherein said synchronizing step comprising a step of selecting a format from a group consisting of bitmap time synchronizing, cue point event synchronization, or a combination thereof.

104. The method according to claim 101, comprising an additional step of registering viewer actions upon images embedded within said overlay layer, said actions selected from a group consisting of: clicks, cursor impressions, mouse over, mouse over duration, or a combination thereof; of an additional step of hyperlinking said viewer actions, or a combination thereof.

105. The method according to claim 101, comprising an additional step of emulating the behavior of standard HTML, thereby causing Ad Servers to treat images contained within said overlay layer as if they were standard banners served on standard HTML pages.

106. The method according to claim 101, comprising an additional step of masking objects embedded in said content layer by superimposing said objects with SIDs embedded in said overlay layer.

107. The method according to claim 101, provided in case that said step of masking provides a visible margin of the masked object visible, comprising an additional step of analyzing the pixels surrounding said masked object within said content layer, and inserting a visual patch in the dimension of said visible margins and in the color and texture composition of said surrounding pixels into said overlay layer, thereby masking said margins by said patch.

108. A method for charging revenue on registered viewer actions selected from a group viewer registered actions selected from a group consisting of clicks, cursor impressions, mouse over, mouse over duration, active hyperlinks, or a combination thereof; upon images or products, said method comprising steps of:
a. obtaining a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream;
b. emulating the behavior of standard HTML, thereby causing Ad Servers to treat images contained within said overlay layer as if they were standard banners served on standard HTML pages;
c. counting registered viewer actions on said images; and,
d. calculating revenue charges;
wherein said emulation of the behavior of standard HTML page causes Ad Servers to treat images and placement zones contained within said overlay layer as if they were standard banners served on standard HTML pages.

109. An authoring tool adapted for embedding SIDs in a video overlay layer, comprising:
a. at least one means for capturing at least one still bitmap of said feed of said content;
b. at least one user interface adapted for indicating upon said captured bitmap: placement zones, objects, objects to be tracked, or a combination thereof; and,
c. at least one database of SIDs adapted for embedding in said overlay layer;
wherein a graphical laymen can generate an overlay layer by self service means.

110. The authoring tool according to claim 109, wherein said authoring tool is a web application.

111. The authoring tool according to claim 109 additionally comprising means for indicating margins that require patching in order to fix visual discrepancies caused by masking an object within said content by an object within said overlay layer.

112. The authoring tool according to claim 109, wherein said user interface is adapted as graphic user interface (GUI) for drag-and-drop insertion of said SIDs in said overlay layer.

113. A method for efficient utilization of web resources in the delivery of video content superimposed by a video overlay layer to a viewer, comprising:
a. obtaining a system a SID placement system adapted to overlay a content video with an electronic overlay layer embedded with a plurality of SIDs, comprising one or more members of a group consisting of video content stored on at least one first server; means for analyzing said content; means for creating an electronic overlay layer adapted to be seamlessly superimposed upon said content; first means for streaming said content layer; second means for streaming said overlay layer; means for synchronizing said first stream with said second stream;
b. storing unaltered video content at a first remote server location by the owner of said content, in the format of their choice; and,
c. storing an overlay layer, produced in advance to match said video content, stored at a second remote server by the producer of said overlay layer;
wherein due to the separate storage of said content and said overlay layer, the data traffic to said viewer is split between two separate web resources.

114. The system according to claim 95, wherein the visual characteristics of said SID are selected from a group consisting of opaque, semi-transparent, transparent, 2 dimensional (2D), 3 dimensional (3D) or a combination thereof

115. The system according to claim 95, wherein said overlay layer additionally comprising means for superimposing at least one SID upon said content layer, said image selected from a group consisting of: still images, films, augmented reality, illustrations, highlights, script, animation, hologram, hyperlink, or a combination thereof
